(19) United States
(12) Patent Application Publication
(10) Pub. No.: US 2018/0022273 A1
(43) Pub. Date: Jan. 25, 2018

(54) WARNING TRIANGLE DISPLAYING INFORMATION TO OTHER ROAD USERS

(71) Applicant: HON HAI PRECISION INDUSTRY CO., LTD., New Taipei (TW)

(72) Inventor: WEN-KAI CHIANG, New Taipei (TW)

(21) Appl. No.: 15/257,927

(22) Filed: Sep. 7, 2016

(30) Foreign Application Priority Data
Jul. 22, 2016 (CN) 201610591528.X

(51) Int. Cl. B60Q 1/52

(52) U.S. Cl. CPC B60Q 1/52

(57) ABSTRACT

A warning triangle includes a warning board and a warning strip. The warning board includes at least two wheels for mobility and the warning strip is placed along the road between an automobile and the warning board. A first warning strip terminal is connected to the warning board, and a second warning strip terminal includes a power interface to connect to an automobile power source. The warning board receives power via the power interface, the warning board and the warning strip are configured to output a distance warning mark or a request for assistance.

### FIELD

The subject matter herein generally relates to driving safety.

### BACKGROUND

When an automobile malfunctions or emergency occurs, in order to secure the automobile safety, a warning triangle is required to be placed behind the automobile. However, there is no warning as to safe distance between the automobile and the warning triangle or other warning.

### BRIEF DESCRIPTION OF THE DRAWINGS

Implementations of the present technology will now be described, by way of example only, with reference to the attached figures.

FIG. 1 is a diagram of an embodiment of a warning triangle of the present disclosure.

FIG. 2 is a block diagram of an embodiment of a warning strip of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure. It should be noted that references to “an” or “one” embodiment in this disclosure are not necessarily to the same embodiment, and such references mean “at least one”.

Several definitions that apply throughout this disclosure will now be presented.

The term “coupled” is defined as connected, whether directly or indirectly through intervening components, and is not necessarily limited to physical connections. The connection can be such that the objects are permanently coupled or releasably coupled. The term “comprising,” when utilized, means “including, but not necessarily limited to”; it specifically indicates open-ended inclusion or membership in the so-described combination, group, series and the like.

The disclosure is described in relation to a warning triangle.

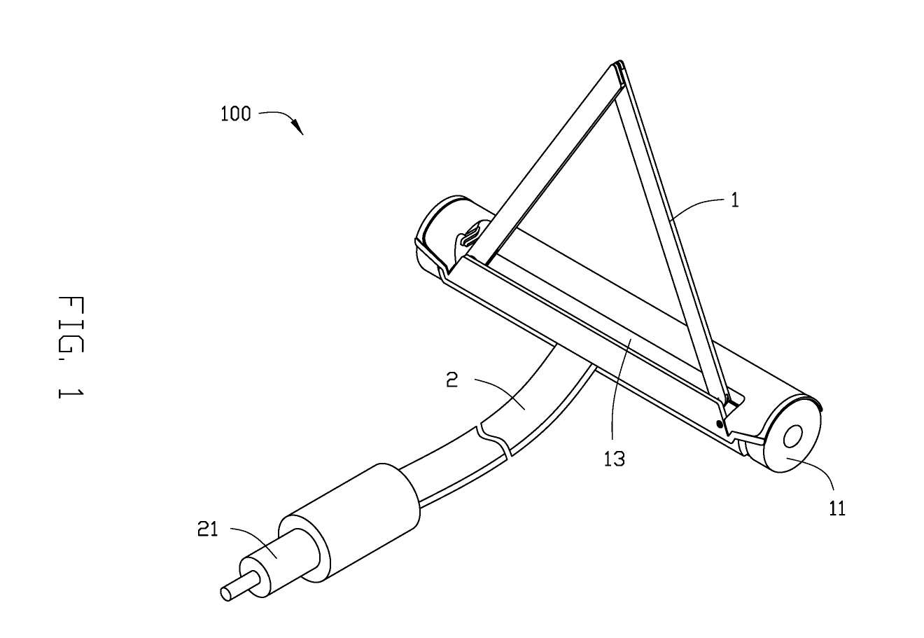

FIG. 1 illustrates an embodiment of a warning triangle 100.

The warning triangle 100 comprises a warning board 1 and a warning strip 2. A warning strip first terminal is connected to the warning board 1. A warning strip second terminal comprises a power interface 21. The power interface 21 can be connected to a power source 3. The power source 3 can supply power to the warning board 1 via the power interface 21. The warning board 1 and the warning strip 2 are configured to output a distance warning mark or other information such as a request for assistance.

In one embodiment, the power source 3 can be power source in an automobile. The distance warning mark comprises lighted signal and/or character signal. The warning strip 2 can be a long flexible strip that can be folded.

When the warning triangle 100 is connected to an automobile, the warning board 1 and the warning strip 2 are configured to output a distance warning mark or other information such as a request for assistance to the automobile. The warning strip 2 can be a reflective strip. The reflective strip can supply a distance warning between the automobile and the warning board 1. The warning strip 2 also can comprise multiple light sources 24. The multiple light sources 24 receive power via the power interface 21 to output the distance warning between the automobile and the warning board 1.

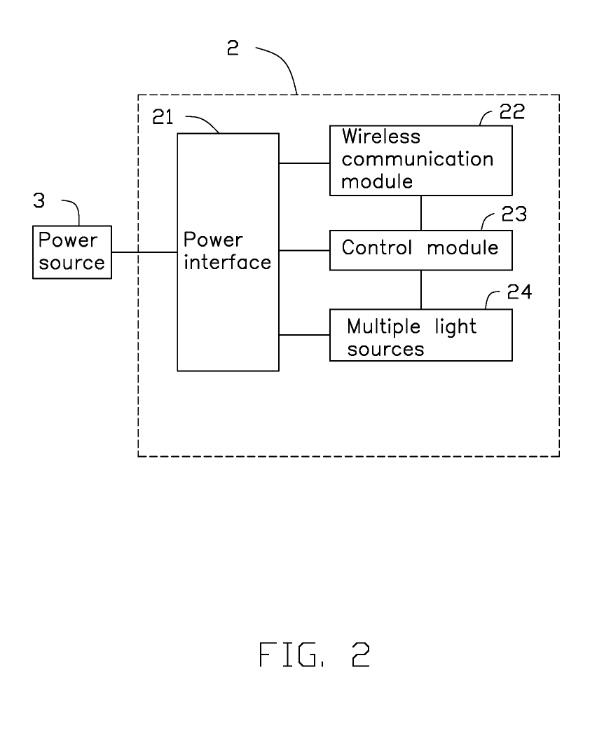

Referring to FIG. 2, the warning strip 2 further comprises a wireless communication 22 and a control module 23. The wireless communication 22 can communicate with a mobile device and receive control signals outputted by the mobile device.

The control module 23 controls the multiple light sources 24 to output a user-defined warning mark according to the control signals received by the wireless communication 22. The user-defined warning mark can be a flashing warning signal and/or a predetermined pattern warning signal. For example, the user-defined warning mark can be a flashing SOS signal.

In one embodiment, the warning strip 2 can be used as lighting. The warning strip 2 further receives the control signals via the power interface 21, and the control signals can be outputted by the automobile.

The warning board 1 comprises at least two wheels 11. The two wheels 11 can rotate to enable easy movement. When the warning triangle 100 starts up, the warning strip 2 may be in a folding state, and the warning board 1 can place the warning strip 2 along the path between the automobile and the warning board 1. Thus when the automobile is parked and needs to set a distance warning mark or a request for assistance, the warning triangle 100 can be connected to the automobile and the warning board 1 and the warning strip 2 placed behind the automobile.

In one embodiment, the warning board 1 further comprises a emergency power source 13. The emergency power source 13 can be charged via the power interface 21. When an electrical connection to the automobile is not present, the warning triangle 100 can obtain power from the emergency power source 13.

While the disclosure has been described by way of example and in terms of the embodiment, it is to be understood that the disclosure is not limited thereto. On the contrary, it is intended to cover various modifications and similar arrangements as would be apparent to those skilled in the art. Therefore, the range of the appended claims should be accorded the broadest interpretation so as to encompass all such modifications and similar arrangements.

1. A warning triangle comprising:
a warning board; and
a warning strip, and a first warning strip terminal connected to the warning board, and a second warning strip terminal comprising a power interface to connect to an automobile power source;
wherein the warning board receives power via the power interface, and the warning board and the warning strip are configured to output a distance warning mark or a request for assistance; the warning strip further comprises multiple light sources, the multiple light sources receive power via the power interface to output the distance warning mark or the request for assistance; the warning strip is configured to receive control signals to control the multiple light sources; and the distance warning mark outputted by the multiple light sources comprises a flashing warning signal and/or a predetermined pattern warning signal; wherein the warning strip is further configured to receive the control signals via the power interface.

2-3. (canceled)

4. (canceled)

5. (canceled)

6-9. (canceled)

10. A warning triangle, comprising:
a warning board comprising at least two wheels; and
a warning strip, and a first warning strip terminal connected to the warning board, and a second warning strip terminal comprising a power interface to connect to an automobile power source;
wherein the warning board receives power via the power interface, the warning board and the warning strip are configured to output a distance warning mark or a request for assistance, and the warning board is further configured to place the warning strip along the path between an automobile and the warning board; the warning strip further comprises multiple light sources, the multiple light sources receive power via the power interface to output the distance warning mark or the request for assistance; the warning strip is configured to receive control signals to control the multiple light sources; and the distance warning mark outputted by the multiple light sources comprises a flashing warning signal and/or a predetermined pattern warning signal; wherein the warning strip is further configured to receive the control signals via the power interface.

11-12. (canceled)

13. (canceled)

14. (canceled)

15. (canceled)

16-18. (canceled)
